(19) United States
(12) Patent Application Publication
(10) Pub. No.: US 2014/0235773 A1
(43) Pub. Date: Aug. 21, 2014

(54) LED DEVICE, POLYSILOXANE COMPOUND AND BASE FORMULA FOR LED DEVICE

(71) Applicant: CSI CHEMICAL COMPANY LIMITED, New Taipei City (TW)

(72) Inventors: SONG KE, NEW TAIPEI CITY (TW); CHIH WEI HUANG, NEW TAIPEI CITY (TW)

(73) Assignee: CSI CHEMICAL COMPANY LIMITED, New Taipei City (TW)

(21) Appl. No.: 14/182,449

(22) Filed: Feb. 18, 2014

(30) Foreign Application Priority Data
Feb. 18, 2013 (TW) 102105534
Jul. 15, 2013 (TW) 102125255

(51) Int. Cl. C08L 83/04

(52) U.S. Cl. CPC C08L 83/04
USPC 524/145; 524/432; 524/425; 524/404; 524/428; 524/413

(57) ABSTRACT

A polysiloxane compound for LED device includes (A) cage-shaped, mesh-shaped or chain-shaped polysiloxane containing alkenyl groups, (B) polysiloxane containing Si—H bonds, (C) a filler composition with a protective function, and (D) a catalyst with ene hydrogen silylation reaction. The filler composition with a protective function is selected from the group of high thermal conductivity material, flame retardant, anti-aging material, UV-resistant material, gas-barrier material, thermal expansion suppression material and/or high temperature-resistant material that are suitable for use in the base, lamp cup and/or encapsulation body of the LED device to effectively improves the lifespan and operational stability of the LED device.

The present invention relates to LED technology and more particularly, to a polysiloxane compound for LED device, a material formula for the base, lamp cup and/or package of a LED device, and a LED device.

In the development of LED lighting technology, many manufacturers or scholars, aiming at material properties, have created materials for LED device that effectively enhance LED operational stability or lifespan. Exemplars are seen in Taiwan Patent 1373478 “thermosetting resin composition, LED package and its fabrication method, and optical semiconductor”; U.S. Pat. No. 7,615,387 “Addition curing silicone composition capable of producing a cured product with excellent crack resistance” and U.S. Pat. No. 7,705,104 “Addition curable silicon resin composition for light emitting diode”.

The former material research and development studies are generally focused on LED encapsulation body, few of them are focused on the base, substrate and/or lamp cup for LED. Siloxane-based materials are commonly used in new materials for LED encapsulation body, however, siloxane-based materials are usually very difficult to have a good bonding with other material groups.

Further, in a LED device, the encapsulation body and the base are normally made from different materials that differ in cold and hot weather shrinkage. Therefore, the problem of component detachment or cracked adhesive can occur in a LED device using the aforesaid prior art base or lamp cup formula due to insecure bonding or inconstant shrinkage when it is used under a high temperature and high humidity environment, affecting the operational stability and lifespan of the LED device.

### SUMMARY OF THE PRESENT INVENTION

It is, therefore, the main object of the present invention to provide a polysiloxane compound for LED device, a material formula for the base, lamp cup and/or package of a LED device, and a LED device, that improves the drawbacks of prior art material formulas for LED device, enhancing LED device operational stability and prolonging LED life span.

To achieve the above mentioned and other objectives, the present invention provides a polysiloxane compound for LED device application, comprising: (A) Cage shaped, mesh shaped or chain shaped polysiloxane containing alkenyl groups, having the overall average composition as indicated in the following structural formula (1): R¹ₙSiO_{(4-n)/2} (1); (B) Si—H bond contained polysiloxane, having the overall average composition as indicated in the following structural formula (2): R³ₐH_{b}SiO_{(4-a-b)/2} (2); (C) Filler composition having a protective function; and (D) Catalyst with ene hydrogen silylation reaction.

The present invention provides a base formula for LED device comprising a polysiloxane compound.

The present invention provides a base formula for LED device.

The present invention provides a LED device comprising a base, wherein said base is made from a polysiloxane compound.

In one embodiment of the polysiloxane compound, the range of n in said structural formula (1) in the composition (A) is within 1˜2.

In one embodiment of the polysiloxane compound, said filler composition is selected from the group of high thermal conductivity materials, flame retardants, anti-aging materials, UV-resistant materials, high temperature-resistant materials, gas-barrier materials, thermal expansion suppression materials, and their combinations.

In one embodiment of the polysiloxane compound, said filler composition is selected from the group of silicon nitride, silicon carbide, aluminum hydroxide, organic chlorides, organic bromides, red phosphorus, phosphate esters, halogenated phosphate esters, nitrogenated flame retardants, organic halogen monomers, organic phosphorus monomers, silica, metal oxides, calcium carbonate, carbon nanotube, carbon nano-fibers, graphene, baron nitride, metal nitrides, carbon fibers, graphite, diamond, carbon, ceramics, nano mica, antiperovskite manganese nitrogen compounds, and their combinations.

In one embodiment of the polysiloxane compound, said Si—H bond contained polysiloxane of the composition (B) is a cage shaped, mesh shaped or chain shaped polysiloxane containing hydrosilyl group; the content of said cage shaped, mesh shaped or chain shaped polysiloxane containing alkenyl groups of the composition (A) is in the range of 1˜99 wt %; the content of said hydrosilyl group contained polysiloxane of the composition (B) is in the range of 1˜40 wt %; the content of filler composition having a protective function of the composition (C) is in the range of 1˜90 wt %; the content of said catalyst with ene hydrogen silylation reaction of the composition (D) is effective catalytic amount up to 500 weight ppm, based on the overall weight of polysiloxane.

In one embodiment of the polysiloxane compound, the content of said catalyst with ene hydrogen silylation reaction in the composition (D) is preferably within the range of 1˜50 ppm.

In one embodiment of the polysiloxane compound, said catalyst with ene hydrogen silylation reaction in the composition (D) is selected from the group of platinum-based catalysts, palladium-based catalysts and rhodium-based catalysts.

In one embodiment of the polysiloxane compound, said base comprises a substrate and/or a lamp cup.

In one embodiment of the polysiloxane compound, further comprises an encapsulation body made from a polysiloxane compound.

### BRIEF DESCRIPTION OF THE DRAWINGS

FIG. 1 is a schematic sectional structural view of a LED device in accordance with a first embodiment of the present invention.

FIG. 2 is a schematic sectional structural view of a LED device in accordance with a second embodiment of the present invention.

### DETAILED DESCRIPTION OF THE PREFERRED EMBODIMENTS

A polysiloxane compound for LED device application of the invention, comprising:
(A) Cage shaped, mesh shaped or chain shaped polysiloxane containing alkenyl groups, having the overall average composition as indicated in the following structural formula (1):

R¹ₙSiO_{(4-n)/2} (1);

in which R¹: independent monovalent hydrocarbyl group, alkoxy group or hydroxyl group with or without a substituent selected from the group of halo, alkyl, cycloalkyl, aryl; n is a positive number, and 0≦n≦2.

The thermoformable polysiloxane and filler composition with protective function in accordance with the present invention comprise:

(B) Si—H bonds-contained polysiloxane of overall average composition as indicated by structural formula (2):

R³ₐH_{b}SiO_{(4-a-b)/2} (2)

in which R³: independent monovalent hydrocarbyl group, alkoxy group or hydroxyl group, excluding alkenyl group with or without a substituent selected from the group of halo, alkyl, cycloalkyl, aryl and alkoxy; a and b are positive numbers.

The thermoformable polysiloxane and filler composition with protective function in accordance with the present invention can have the following composition be added thereto:

(C) a filler material with protective function containing high thermal conductivity material, flame retardant, anti-aging material, UV-resistant material, high temperature-resistant material, gas-barrier material, thermal expansion suppression material (Thermal Expansion Inhibitor) and their combinations. For example, select from the group of silicon nitride (Si₃N₄), silicon carbide (SiC), aluminum hydroxide (Al(OH)₃), organic chlorides, organic bromides, red phosphorus, phosphate esters, halogenated phosphate esters, nitrogenated flame retardant, organic halogen monomer, organic phosphorus monomer, silica (SiO₂), metal oxides, calcium carbonate, carbon nanotube (Carbon Nanotube), carbon nano-fibers (Nano Fiber), graphene (Graphene), baron nitride, metal nitrides, carbon fibers, graphite, diamond, carbon, ceramics, nano mica (Nano Mica), antiperovskite manganese nitrogen compounds (Anti-Perovskite Structure Mn3XN (X═Ge—Zn—Sn—Cu—Ge) and their combinations. The metal oxides are preferably selected from, but not limited to, the group of aluminum oxide (Al₂O₃), chromium trioxide (Cr₂O₃), zinc peroxide (ZnO₂) and titanium dioxide (TiO₂). The metal nitrides is preferably, but not limited to, aluminum nitride.

In one embodiment of the present invention, the amount of silicon carbide (SiC) of the composition is in the range of 2 wt %˜20 wt %; the amount of aluminum oxide (Al₂O₃) is in the range of 10 wt %˜100 wt %; the amount of aluminum hydroxide (Al(OH)₃) is in the range of 5 wt %˜50 wt %; the amount of zinc peroxide (ZnO₂) is in the range of 1 wt %˜10 wt %; the amount of titanium dioxide (TiO₂) is in the range of 1 wt %˜10 wt %; the amount of flame retardant is in the range of 5 wt %˜80 wt %.

The thermoformable polysiloxane and filler composition with protective function can have the following composition added thereto:

(D) Catalyst with ene hydrogen silylation reaction selected from platinum-based, palladium-based or rhodium-based catalysts, or their combinations.

In the present invention, there is no special limited to the content of the catalyst of the composition (D), normally, any effective catalytic amount can be accepted. Based on the total weight of polysiloxane as a reference, the amount of the catalyst of the composition (D) can be 500 ppm maximum, or preferably in the range of 0.1˜100 ppm, or most preferably in the range of 1˜50 ppm.

The thermoformable polysiloxane and filler composition with protective function of the present invention are suitable for use in the fabrication of a base (substrate/lamp cup) and/or encapsulation body for LED device.

It is another object of the present invention to provide a formula for the base (substrate and/or lamp cup) for LED device that comprises the thermoformable polysiloxane and filler composition with protective function prepared according to the present invention.

The advantages and features of the present invention will be fully understood by reference to the following specification in conjunction with the accompanying drawings. In the present preferred embodiment, A represents case-shaped, mesh-shaped or chain-shaped polysiloxane containing alkenyl groups: B represents Si—H bond contained polysiloxane; C represents filler composition having a protective function that contains high thermal conductivity material, flame retardant, anti-aging material, UV-resistant material, high temperature-resistant material or their combinations; D represents catalyst with ene hydrogen silylation reaction.

In one embodiment of the present invention, B is preferably cage-shaped, mesh-shaped or chain-shaped polysiloxane containing Si—H bonds. However, this is not a limitation.

### [Preparation of Test Samples]

(1). Fill formulated material for base or lamp cup in a mating mold and then heat the mold to cure the applied material and then open the mold to take out the cured material for application; and

(2). Prepare an encapsulation adhesive selected from the same material group and then fill the encapsulation adhesive into the lamp cup (or rack) obtained in step (I), and then enable the lamp cup (or rack) with the filled encapsulation adhesive to be thermally cross-linked and cured at 60° C. for 1 hour or 120° C. for 2 hours, thereby obtaining a test sample.

### [Characteristic Assessment]

(1). Red Ink Test

Dip the encapsulated and cured LED device sample in a red ink supplied by Merck, and then heat the red ink to 80° C. for 24 hours, and then pick up the LED device from the red ink, and then wash the LED device sample with clean water, and then wipe dry the LED device sample, and then use an optical microscope to observe whether or not the red ink permeates into the LED device sample.

O: No red ink permeation is observed under the microscope.

X: Red ink permeation is observed under the microscope.

(2). Reflow Test

Reflow the encapsulated and cured LED device sample at 260° C. three minutes each time and totally 20 times, and then observe the LED device sample with an optical microscope.

O: Neither cracked adhesive, bubbles in adhesive, peeling of bonding surface of the encapsulated and cured LED lamp cup, nor bubbles in bonding surface of the encapsulated and cured LED lamp cup is observed under the microscope.

X: Cracked adhesive, bubbles in adhesive, peeling of bonding surface of the encapsulated and cured LED lamp cup, or bubbles in bonding surface of the encapsulated and cured LED lamp cup are observed under the microscope.

(3). Temperature Cycling Test

Put the encapsulated and cured LED device sample under the environment of 85° C./85% relative humidity for 160 hours, and then enable the sample to be heated to 120° C. for 30 minutes and cooled at −40° C. for 30 minutes and totally in 1000 cycles, and then observe the LED device sample with an optical microscope.

O: Neither cracked adhesive, bubbles in adhesive, peeling of bonding surface of the encapsulated and cured LED lamp cup, nor bubbles in bonding surface of the encapsulated and cured LED lamp cup is observed under the microscope.

X: Cracked adhesive, bubbles in adhesive, peeling of bonding surface of the encapsulated and cured LED lamp cup, or bubbles in bonding surface of the encapsulated and cured LED lamp cup are observed under the microscope.

### [Example of Synthesis]

The material formula of the thermoformable polysiloxane and filler composition with protective function for making a base (substrate and/or lamp cup) for LED device comprises:

(A). Cage-Shaped, Mesh-Shaped or Chain-Shaped Polysiloxane Containing Alkenyl Groups:

Take 30% aqueous hydrochloric acid 100 g and add it to a reaction flask, and then add 400 g ethanol and methyl phenyl dimethoxy silane 50 g, vinyl trimethoxy silane 30 g, phenyl trimethoxy silane 306 g, diphenyl dimethoxy silane 60 g and hexamethyl siloxane 15 g to obtain a reaction mixture.

Thereafter, enable the reaction mixture to be reacted at 40˜90° C. for 2˜6 hours, and then wash the reacted substance with water to neutral, then remove solvent from the substance under reduced pressure.

Thereafter, add 5 g concentrated sulfuric acid (H₂SO₄) to the substance thus obtained, and then process the substance through a series of decompression, heating, dehydration and neutralization processes, and then wash it with water to neutral, and then dehydrate the substance by decompression, thereby obtaining 100 g cage-shaped, mesh-shaped or chain-shaped, alkenyl group-contained polysiloxane.

(B). Polysiloxane Containing Si—H Bonds

Take 30% aqueous hydrochloric acid 100 g and put it in a reaction flask, and then add 400 g ethanol and methyl phenyl dimethoxy silane 50 g, tetrahydro dimethyl siloxane 50 g, phenyl trimethoxy silane 250 g, diphenyl dimethoxy silane 40 g and hexamethyl siloxane 10 g to obtain a reaction mixture.

Thereafter, enable the reaction mixture to be reacted at 40˜90° C. for 2˜6 hours, and then wash the reacted mixture with clean water to neutral, and then remove solvent from the substance thus obtained by decompression.

Thereafter, add 5 g concentrated sulfuric acid (H₂SO₄) to the substance thus obtained, and then process the substance through a series of decompression, heating, dehydration and neutralization processes, and then wash it with water to neutral, and then dehydrate the substance by decompression, thereby obtaining 100 g Si—H bond-contained polysiloxane.

(C). Filler Materials Having a Protective Function that Contains High Thermal Conductivity Material, Flame Retardant, Anti-Aging Material, UV-Resistant Material, High Temperature-Resistant Material or Their Combination

Mix 5 g of SᵢC, 50 g of Al₂O₃, 30 g of Al(OH)₃, 2 g of ZnO₂, 5 g of TiO₂ and 30 g of flame retardant, and then put the mixture in a rotary evaporator furnace to remove water.

(D). Ene Hydrogen Silylation Reaction Catalyst:

It is selected from the group of platinum family, palladium family, rhodium family and their combinations.

### EXAMPLE 1

Take:

(A) 88 grams of cage-shaped, mesh-shaped or chain-shaped polysiloxane containing alkenyl groups;

(B) 10 grams of polysiloxane containing Si—H groups that is a cage-shaped, mesh-shaped or chain-shaped polysiloxane containing hydrosilyl group;

(C) 200 grams of a filler composition having a protective function selected from the group of high thermal conductivity material, flame retardant, anti-aging material, UV-resistant material, high temperature-resistant material and their combinations; and

(D) 50 ppm of catalyst containing alkenyl groups with ene hydrogen silylation reaction.

And then, well mix the selected materials and treat them through a vacuum deaeration process to obtain formulated materials for making base (substrate and/or lamp cup).

### EXAMPLES 2-6

Prepare formula examples for base (substrate and/or lamp cup) by means of mixing and vacuum deaeration procedures subject to the composition and weight (g) listed in the following Table 1:

TABLE 1

| | Formulated Composition | | | | | | | |
|---|---|---|---|---|---|---|---|---|
| | | | | | | | Com. | Com. |
| | Ex. 1 | Ex. 2 | Ex. 3 | Ex. 4 | Ex. 5 | Ex. 6 | Ex. 1 | Ex. 2 |
| (A)-(g) | 88 | 100 | 100 | 100 | 100 | 100 | | |
| (B)-(g) | 10 | 10 | 15 | 5 | 10 | 15 | | |
| (C)-(g) | 200 | 100 | 200 | 200 | 400 | 300 | | |
| (D)-(ppm) | 50 | 50 | 100 | 100 | 50 | 200 | | |
| Red ink test | ◯ | ◯ | ◯ | ◯ | ◯ | ◯ | X | X |
| (80° C./24 h) | | | | | | | | |
| Reflow teat | ◯ | ◯ | ◯ | ◯ | ◯ | ◯ | X | X |
| (260° C./3 min, | | | | | | | | |
| 20 times) | | | | | | | | |
| Temp. Cycling | ◯ | ◯ | ◯ | ◯ | ◯ | ◯ | X | X |
| Test (−40° C./ | | | | | | | | |
| 120° C., 1000 | | | | | | | | |
| times) | | | | | | | | |

The above-said formulated compositions 1˜6 for base (substrate and/or lamp cup) were used to make test samples for comparison with the comparative samples 1 (polyphthal amide lamp cup) and 2 (epoxy lamp cup) through red ink test, reflow test and temperature cycling test (−40° C./120° C.), and thus characteristics assessment results were obtained as indicated in Table 1.

In Table 1, a LED base (substrate or lamp cup) made from the thermoformable polysiloxane compound of the present invention with an encapsulation body subject to Examples 1˜6 are commonly based on polysiloxane and added with at least one filler composition with protective function. When cured to form a LED rack or lamp cup and then encapsulated with the same siloxane material, and then observed under an optical microscope, no red ink permeation was found. Further, after through reflow test and temperature cycling test (tested under the condition of −40° C./120° C.), no any stripping or peeling condition was observed.

In contrast, the comparative sample 1 (PPA lamp cup) and 2 (Epoxy lamp cup) without containing the thermoformable polysiloxane compound of the present invention exhibit poor quality results in red ink test, reflow test and temperature cycling test.

It is obvious that the thermoformable polysiloxane and filler composition with protective function in accordance with the present invention enable a LED rack, base, substrate or lamp cup to have the same hot and cold shrinkage relative to the encapsulation adhesive of the same material group, exhibiting excellent demoulding, desorption, thermo shock resistance characteristics. Further, the thermoformable polysiloxane and filler composition with protective function is practical for hot extrusion molding and suitable for the fabrication of LED base (substrate and/or lamp cup) as well as other commercial applications, facilitating LED base fabrication.

### [LED Device Preparation]

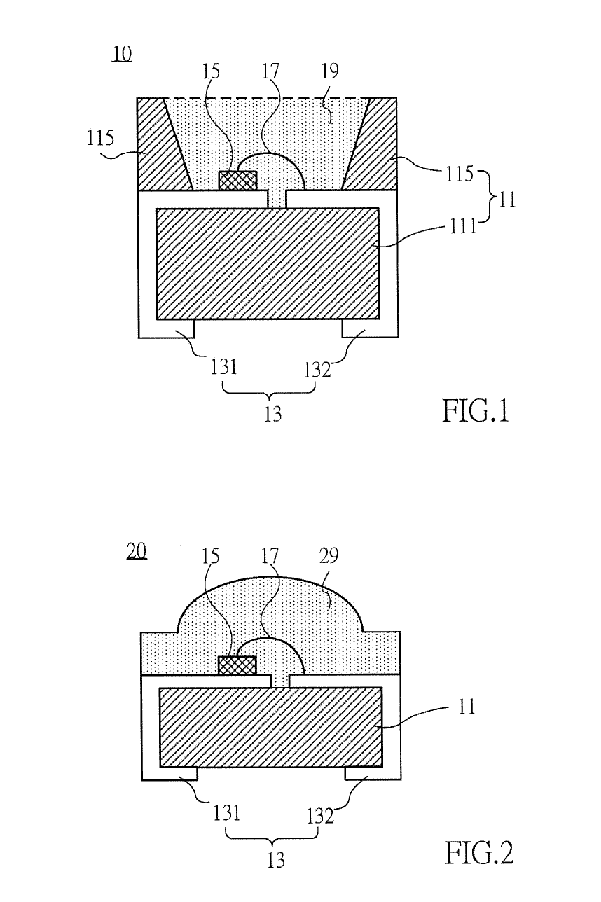

Referring to FIG. 1, a LED device based on the aforesaid polysiloxane and filler composition having a protective function is shown. As illustrated, the LED device 10 is a surface mount device type LED device, also known as chip type LED device or planar LED device, comprising a substrate 111, a plurality of lead frames 13, for example, a first lead frame 131 and a second lead frame 132 separately mounted at the substrate 111, a LED 15 fixedly mounted at the first lead frame 131, and a lead wire 17 electrically connecting the LED 15 to the second lead frame 132 to have the first lead frame 131, the LED 15, the lead wire 17 and the second lead frame 132 constitute a conductive path.

The LED device 10 further comprises a lamp cup (also known as annular body) 115 mounted around the border area of the lead frames 13 and defining with the substrate 111 and the lead frames 13 an open space, a LED 15 mounted in the open space surrounded by the lamp cup 115, the substrate 111 and the lead frames 13, and an encapsulation body 19 molded in the open space to protect the LED 15.

As stated earlier, the polysiloxane compound (containing a filler composition having a protective function) is applicable to the fabrication of the base 1 for the LED device 11, i.e., it can be used for making the substrate 111 and/or lamp cup 115 of the base 11 of the LED device 10.

In a first embodiment of the present invention, the substrate 111 and lamp cup 115 of the base 11 of the LED device 10 and the encapsulation body 19 are made from the same or similar polysiloxane compound, thus, the material properties or chemical properties of these components are relatively close to one another, providing better adhesion and crashworthiness.

Further, if the encapsulation body 19 of the LED device 10 is made from a different material relative to the substrate 111 and/or lamp cup 115 of the base 11 to meet a different luminosity requirement, the polysiloxane compound (containing a filler composition having a protective function) enables the substrate 111 and/or lamp cup 115 of the base 11 to have better protective properties of thermal conductivity, flame retardancy, aging resistance, UV resistance and/or high temperature, assuring high operational stability and prolonging the lifespan of the LED device 10.

Further, in a second embodiment of the present invention, as shown in FIG. 2, the LED device, referenced by 20, is a lens type or convex type LED device. This second embodiment is substantially similar to the aforesaid first embodiment shown in FIG. 1 with the exception that the base 11 is formed of a substrate (111) without the aforesaid lamp cup (115), and the encapsulation body, referenced by 29, is made in the form of a convex (or concave) lens.

Similar to the aforesaid first embodiment, the base 11 and/or the encapsulation body 29 can also be made from the aforesaid polysiloxane compound (containing a filler composition having a protective function), enhancing the operational stability of the LED device 20 and prolonging its lifespan.

Although particular embodiments of the invention have been described in detail for purposes of illustration, various modifications and enhancements may be made without departing from the spirit and scope of the invention. For example, the single quantifier (such as one or the) described in the specification can also be multiple unless otherwise specifically defined, i.e., one member can be a combination of two or more components, and one substance can be a combination of multiple substances. Accordingly, the invention is not to be limited except as by the appended claims.

What is claimed is:

1. A polysiloxane compound for LED device application, comprising:
(A) Cage shaped, mesh shaped or chain shaped polysiloxane containing alkenyl groups, having the overall average composition as indicated in the following structural formula (1):
R¹ₙSiO_{(4-n)/2} (1);
(B) Si—H bond contained polysiloxane, having the overall average composition as indicated in the following structural formula (2):
R³ₐH_{b}SiO_{(4-a-b)/2} (2);
(C) Filler composition having a protective function; and
(D) Catalyst with ene hydrogen silylation reaction.

2. The polysiloxane compound as claimed in claim 1, wherein the range of n in said structural formula (1) in the composition (A) is within 1˜2.

3. The polysiloxane compound as claimed in claim 1, wherein said filler composition is one of high thermal conductivity materials, flame retardants, anti-aging materials, UV-resistant materials, high temperature-resistant materials, gas-barrier materials, thermal expansion suppression materials, or a combination thereof.

4. The polysiloxane compound as claimed in claim 3, wherein said filler composition is one of silicon nitride, silicon carbide, aluminum hydroxide, organic chlorides, organic bromides, red phosphorus, phosphate esters, halogenated phosphate esters, nitrogenated flame retardants, organic halogen monomers, organic phosphorus monomers, silica, metal oxides, calcium carbonate, carbon nanotube, carbon nano-fibers, graphene, baron nitride, metal nitrides, carbon fibers, graphite, diamond, carbon, ceramics, nano mica, antiperovskite manganese nitrogen compounds, or a combination thereof.

5. The polysiloxane compound as claimed in claim 1, wherein said Si—H bond contained polysiloxane of the composition (B) is a cage shaped, mesh shaped or chain shaped polysiloxane containing hydrosilyl group; the content of said cage shaped, mesh shaped or chain shaped polysiloxane containing alkenyl groups of the composition (A) is in the range of 1˜99 wt %; the content of said hydrosilyl group contained polysiloxane of the composition (B) is in the range of 1˜40 wt %; the content of filler composition having a protective function of the composition (C) is in the range of 1˜90 wt %; the content of said catalyst with ene hydrogen silylation reaction of the composition (D) is effective catalytic amount up to 500 weight ppm, based on the overall weight of polysiloxane.

6. The polysiloxane compound as claimed in claim 5, wherein the content of said catalyst with ene hydrogen silylation reaction in the composition (D) is preferably within the range of 1˜50 ppm.

7. The polysiloxane compound as claimed in claim 1, wherein said catalyst with ene hydrogen silylation reaction in the composition (D) is platinum-based catalysts, palladium-based catalysts or rhodium-based catalysts.

8. A base formula for LED device, comprising a polysiloxane compound, comprising:
(A) Cage shaped, mesh shaped or chain shaped polysiloxane containing alkenyl groups, having the overall average composition as indicated in the following structural formula (1):
R¹ₙSiO_{(4-n)/2} (1);
(B) Si—H bond contained polysiloxane, having the overall average composition as indicated in the following structural formula (2):
R³ₐH_{b}SiO_{(4-a-b)/2} (2);
(C) Filler composition having a protective function; and
(D) Catalyst with ene hydrogen silylation reaction.

9. The base formula as claimed in claim 8, wherein the range of n in said structural formula (1) in the composition (A) is within 1˜2.

10. The base formula as claimed in claim 8, wherein said filler composition is one of high thermal conductivity materials, flame retardants, anti-aging materials, UV-resistant materials, high temperature-resistant materials, gas-barrier materials, thermal expansion suppression materials, or a combination thereof.

11. The base formula as claimed in claim 8, wherein said Si—H bond contained polysiloxane of the composition (B) is a cage shaped, mesh shaped or chain shaped polysiloxane containing hydrosilyl group; the content of said cage shaped, mesh shaped or chain shaped polysiloxane containing alkenyl groups of the composition (A) is in the range of 1˜99 wt %; the content of said hydrosilyl group contained polysiloxane of the composition (B) is in the range of 1˜40 wt %; the content of filler composition having a protective function of the composition (C) is in the range of 1˜90 wt %; the content of said catalyst with ene hydrogen silylation reaction of the composition (D) is effective catalytic amount up to 500 weight ppm, based on the overall weight of polysiloxane.

12. The base formula as claimed in claim 11, wherein the content of said catalyst with ene hydrogen silylation reaction in the composition (D) is preferably within the range of 1˜50 ppm.

13. A LED device comprising a base, wherein said base is made from a polysiloxane compound comprising:
(A) Cage shaped, mesh shaped or chain shaped polysiloxane containing alkenyl groups, having the overall average composition as indicated in the following structural formula (1):
R¹ₙSiO_{(4-n)/2} (1);
(B) Si—H bond contained polysiloxane, having the overall average composition as indicated in the following structural formula (2):
R³ₐH_{b}SiO_{(4-a-b)/2} (2);
(C) Filler composition having a protective function; and
(D) Catalyst with ene hydrogen silylation reaction.

14. The LED device as claimed in claim 13, wherein the range of n in said structural formula (1) in the composition (A) is within 1˜2.

15. The LED device as claimed in claim 13, wherein said filler composition is one of high thermal conductivity materials, flame retardants, anti-aging materials, UV-resistant materials, high temperature-resistant materials, gas-barrier materials, thermal expansion suppression materials, or a combination thereof.

16. The LED device as claimed in claim 13, wherein said Si—H bond contained polysiloxane of the composition (B) is a cage shaped, mesh shaped or chain shaped polysiloxane containing hydrosilyl group; the content of said cage shaped, mesh shaped or chain shaped polysiloxane containing alkenyl groups of the composition (A) is in the range of 1˜99 wt %; the content of said hydrosilyl group contained polysiloxane of the composition (B) is in the range of 1˜40 wt %; the content of filler composition having a protective function of the composition (C) is in the range of 1˜90 wt %; the content of said catalyst with ene hydrogen silylation reaction of the composition (D) is effective catalytic amount up to 500 weight ppm, based on the overall weight of polysiloxane.

17. The LED device as claimed in claim 16, wherein the content of said catalyst with ene hydrogen silylation reaction in the composition (D) is preferably within the range of 1˜50 ppm.

18. The LED device as claimed in claim 13, wherein said base comprises one of a substrate, a lamp cup, or a combination thereof.

19. The LED device as claimed in claim 13, further comprising an encapsulation body made from said polysiloxane compound.
